(19) United States
(12) Patent Application Publication
(10) Pub. No.: US 2012/0093582 A1
(43) Pub. Date: Apr. 19, 2012

(54) ASPHALT DISTRIBUTION DEVICE

(76) Inventors: Scott Wilcox, Hereford, TX (US); Ron Hathaway, Hereford, TX (US)

(21) Appl. No.: 12/907,669

(22) Filed: Oct. 19, 2010

(51) Int. Cl. E01C 7/35; B23P 11/00; E01C 19/12

(52) U.S. Cl. 404/72; 404/101; 29/428

(57) ABSTRACT

A system for distributing asphalt includes a vehicle and a distribution compartment coupled to the vehicle. The distribution compartment includes a support member, a laterally elongated element coupled to the support member, and two or more lateral containment members operatively coupled to the support member for inhibiting the escape of asphalt from the distribution compartment when asphalt is contained therein. At least one of the lateral containment members is laterally movable towards or away from one at least one other lateral containment member.

### BACKGROUND

1. Field of the Invention

The present invention relates to the field of roadway construction equipment. In particular, embodiments relate to asphalt distribution systems and methods of use thereof.

2. Description of the Related Art

Asphalt cement (hereinafter “asphalt”) is a composite material including a viscous liquid or semi-liquid hydrocarbon binder mixed with mineral aggregates. Many transportation surfaces, including major streets, highways, and parking lots, are formed from some variety of asphalt. As such, it is generally desirable to distribute the asphalt in substantially continuous and planar sheets or mats. Various types of machinery are known to facilitate the distribution or “laydown” of asphalt. Typically, these machines include a motor vehicle having a hopper located at the front end. The hopper is designed to receive asphalt from an external source (often a dump truck). The vehicle may further include a conveyor system for transporting the received asphalt from the hopper to the rear end of the vehicle and dispensing the asphalt onto the ground in front of a leveling screed towed by the vehicle. Augers are frequently used to ensure that the asphalt is distributed evenly in the lateral direction in front of the screed. The dispensed asphalt is fed under the screed and thus a substantially planar mat of asphalt is laid behind the vehicle as the vehicle advances forward.

U.S. Pat. No. 4,379,653 to Brown, the entirety of which is incorporated herein by reference, discloses an asphalt distribution system equipped with a telescoping screed. The screed includes a main portion and two extendable/retractable auxiliary portions. The auxiliary portions are mounted in front of the main portion so that extension and retraction of the auxiliary portions is possible without interrupting the distribution process.

U.S. Pat. No. 5,868,522 to Campbell, the entirety of which is incorporated herein by reference, discloses a vibratory screed for an asphalt distribution system. The screed generally includes a frame coupled to a screed plate and a vibratory assembly. The vibratory assembly is mounted to the screed plate. The vibratory motion effectively enhances the leveling and smoothing action of the screed plate.

U.S. Pat. No. 5,599,134 to Macku et al., the entirety of which is incorporated herein by reference, discloses an asphalt distribution system with a compensation device operable to determine the general profile of the underlying subgrade and responsively alter the thickness of the distributed asphalt in order to distribute a smooth planar mat of asphalt.

It is clear that there has been a significant amount of effort in the art to develop more efficient, effective, and functional asphalt distribution systems. As the equipment has become more technologically advanced, large scale asphalt distribution has become increasingly cost effective. The opposite is frequently true, however, for projects of a smaller scale. The more advanced equipment is often available at an increased price and the savings associated with improved efficiency are usually not as substantial for smaller projects. Further, at present, asphalt distribution equipment for projects with small space constraints is fairly limited. Typically, such equipment is not very functional or efficient. Thus, there is a need for a highly functional, inexpensive, and efficient asphalt distribution system that is adaptable to mid level and small scale projects.

### SUMMARY

A system for distributing asphalt includes a vehicle and a distribution compartment coupled to the vehicle. In some embodiments, the distribution compartment includes a support member and a laterally elongated element coupled to the support member. In certain embodiments the support member is couplable to the vehicle. In some embodiments, the distribution compartment further includes two or more lateral containment members operatively coupled to the support member and extending outward therefrom such that when asphalt is provided to the distribution compartment, the asphalt is inhibited from escaping the distribution compartment laterally. In certain embodiments, at least one of the lateral containment members is laterally movable towards or away from at least one other lateral containment member.

In some embodiments, the system further includes a vertical displacement device operatively coupled to the elongated element for vertically displacing the elongated element relative to the support member.

A method of distributing asphalt includes obtaining an asphalt distribution compartment. In some embodiments, the distribution compartment includes a support member and a laterally elongated element coupled to the support member. In some embodiments, the method further includes loading asphalt into the distribution compartment and propelling the distribution compartment to distribute asphalt. In certain embodiments, the method further includes adjusting the width of the distributed asphalt by moving at least one of the lateral containment members towards or away from at least one other lateral containment member. In certain embodiments, the method further includes vertically displacing the elongated element relative to the support member such that the vertical distance from the elongated element to a level portion of the ground is substantially equal to a selected thickness of the distributed asphalt

In further embodiments, additional features may be added to the specific embodiments described herein.

### BRIEF DESCRIPTION OF THE DRAWINGS

The present invention will be better understood and other advantages will appear on reading the detailed description of some embodiments taken as non-limiting examples and illustrated by the following drawings in which:

FIG. 1 is a perspective view of an embodiment of an asphalt distribution system;

FIG. 2 is a perspective view of an asphalt distribution device;

FIG. 2A is a perspective view of a containment member;

FIG. 2B is an additional view of a containment member;

FIG. 2C is a perspective view of an elongated member;

FIG. 3 is a side view of the asphalt distribution device in FIG. 2;

FIG. 4 is a front view of the asphalt distribution device in FIG. 2;

FIG. 5 is a back view of the asphalt distribution device in FIG. 2;

FIG. 6 depicts the asphalt distribution system in FIG. 1 in use.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF ILLUSTRATIVE EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” Terms relating to orientation, such as “upper”, “lower”, “top”, “bottom”, “left”, or “right”, are used for reference only; the device herein may be used in any orientation. The order of any method may be changed, and various elements may be added, reordered, combined, omitted, modified, etc.

In the context of this application, the following terms are defined as:

“Coupled” means either a direct connection or an indirect connection (e.g., one or more intervening connections) between one or more objects or components. The phrase “directly connected” means a direct connection between objects or components such that the objects or components are connected directly to each other so that the objects or components operate in a “point of use” manner.

A “mechanical fastener” refers to a fastener that is used to couple two or more elements together by force. Examples of a mechanical fastener include, but are not limited to, a bolt, a screw, a pin, a rivet, and a wire.

A “vehicle” refers to any means of conveyance or transport. Examples of a vehicle include, but are not limited to, a truck, a trailer, a car, and a skid steer.

A “self propelled vehicle” refers to a vehicle that carries in itself a means of propulsion, such as, for example, an engine.

The “leading end of a vehicle” refers to the end of the vehicle facing the direction of motion.

A “skid steering vehicle” refers to a vehicle maneuvered at least in part by a method of steering through braking or engaging tracks or wheels on one side of the vehicle.

A “member” refers to a constituent part of a system. A “member” may include a plate, link, or other structure of various sizes, shapes, and forms. A member may be a single component or a combination of components coupled to one another. A member may have various regular or irregular shapes. For example, portions of a member may be straight, curved, or a combination of both.

An “aperture” refers to an opening, such as a hole, gap, or slit.

“Elongated” means having more length than width.

An “elongated element” refers to any object having more length than width.

A “leveling surface” refers to any surface of an elongated element configured to engage asphalt.

A “housing” refers to a structure surrounding an internal space.

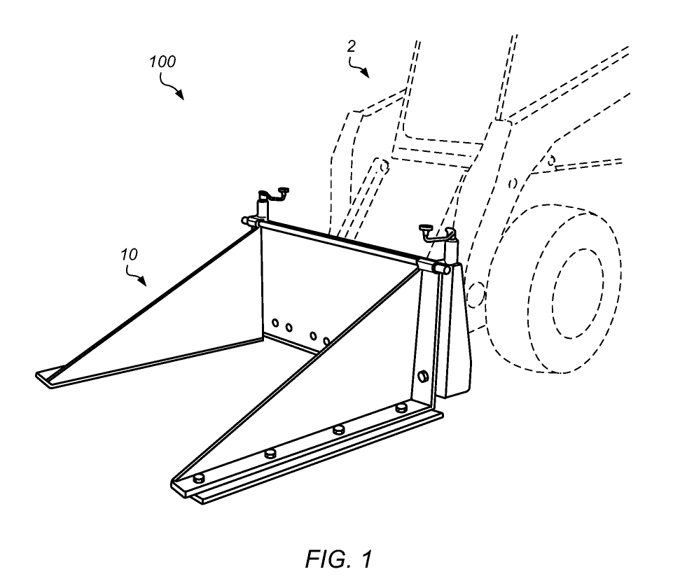

FIG. 1 illustrates an embodiment of a system for distributing asphalt. Asphalt distribution system 100 includes asphalt distribution device 10 coupled to vehicle 2 (for clarity, only a portion of vehicle 2 is shown in FIG. 1). Distribution device 10 may be coupled to vehicle 2 by any suitable means and/or method. In some embodiments, vehicle 2 is self propelled. In various embodiments, vehicle 2 is a skid steering vehicle. It may be advantageous to couple the asphalt distribution device to a skid steering vehicle in order to provide a highly maneuverable system for distributing asphalt. In certain embodiments, asphalt distribution device 10 is coupled to the leading end of vehicle 2. Coupling the asphalt distribution device to the leading end of the vehicle may advantageously allow the vehicle to maneuver with better control and handling.

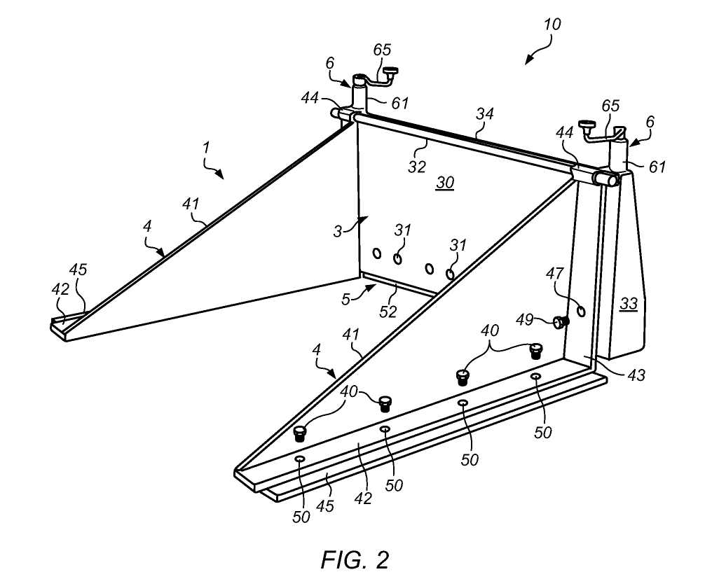

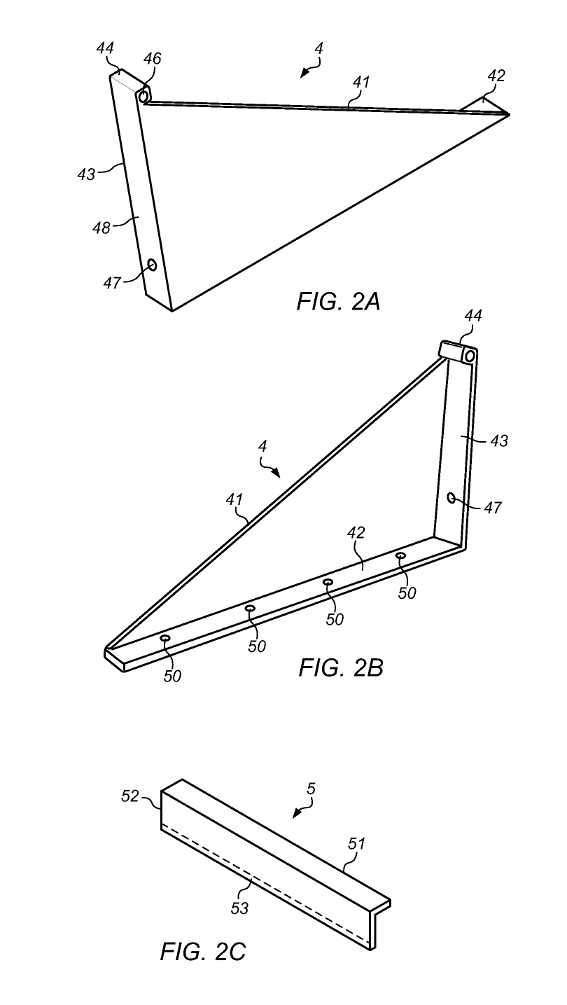

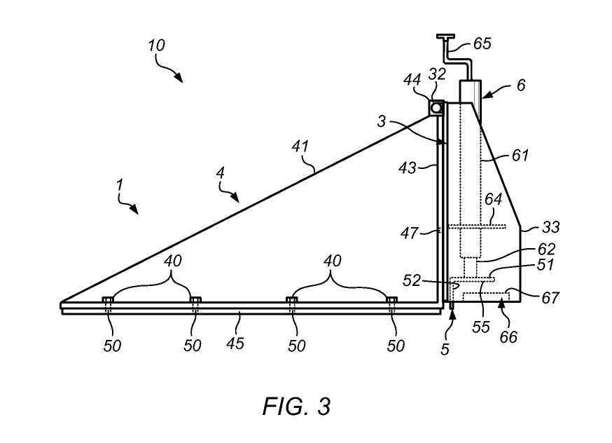

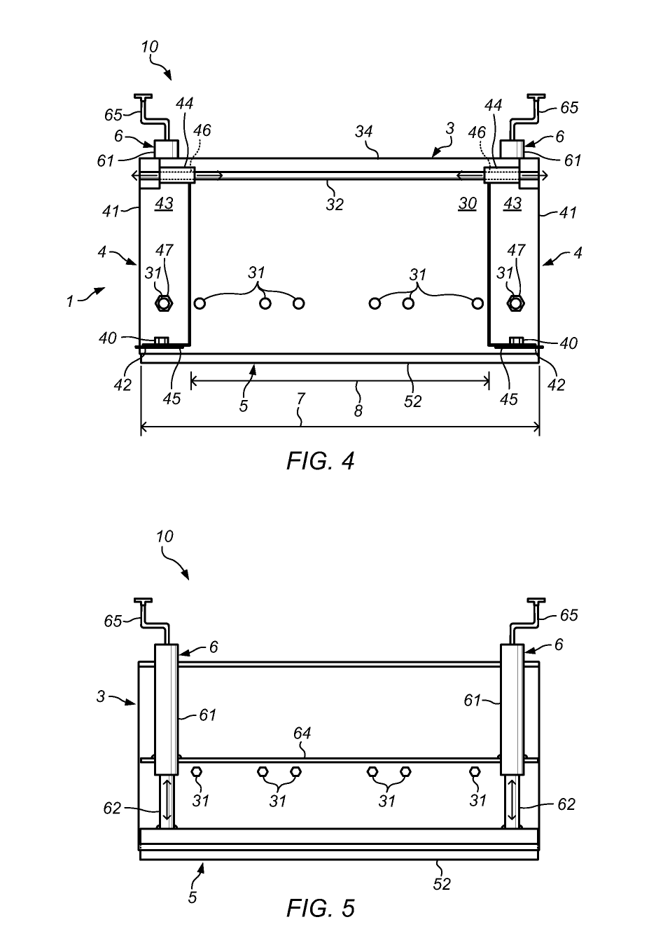

FIGS. 2-5 depict asphalt distribution device 10 in detail. Asphalt distribution device 10 includes distribution compartment 1 having width 7 (see FIG. 4). Distribution compartment 1 is configured to receive asphalt from an external source. In some embodiments, width 7 of distribution compartment 1 is at most about ten feet (approximately 3.05 meters). In various embodiments, width 7 is at most about seven feet (approximately 2.13 meters). In certain embodiments, width 7 is at most about five feet (approximately 1.52 meters). In such certain embodiments, asphalt distribution system 1 is advantageously suited for efficiently repairing small patches of roadway. Further, the total weight of distribution compartment 1 may be reduced, thereby reducing the amount of power required to propel the distribution compartment.

In some embodiments, distribution compartment 1 is configured to receive and distribute asphalt during use. As such, additional components including hoppers, augers, conveying means, and the like are not requisite constituents of the asphalt distribution system described herein. Thus, in some embodiments, the asphalt distribution system may be composed of fewer parts and provided at a lower cost.

Distribution compartment 1 includes lateral containment members 4 coupled to support member 3. Support member 3 may at least partially support lateral containment members 4. Support member 3 is couplable to vehicle 2. In some embodiments, support member 3 is couplable to a universal mounting plate for a skid steering vehicle. According to the depicted embodiment, support member 3 is a rectangular prism. A support member, however, may be any suitable shape or size.

In some embodiments, the distribution compartment includes one or more heating elements operatively coupled the containment members or the support member for maintaining the temperature of the asphalt.

Support member 3 includes apertures 31. Apertures 31 may be used to fixedly couple lateral containment members 4 to support member 3. In some embodiments, apertures 31 are aligned on a single horizontal plane. In certain embodiments, apertures 31 are positioned at selected locations on support member 3. For example, apertures 31 may be positioned at selected horizontal distances from the center or lateral edges of support member 3.

Elongated shaft 32 is coupled to support member 3 and positioned horizontally thereon proximate edge 34 of surface 30. According to the depicted embodiment, elongated shaft 32 is tubular. An elongated shaft, however, may be any suitable shape or size. Elongated shaft 32 may also at least partially support lateral containment members 4.

Lateral containment members 4 include containment plates 41. Containment plates 41 protrude outward with respect to surface 30 of support member 3. In some embodiments, containment plates 41 protrude outward normally (i.e., at a 90° angle) with respect to surface 30. In some embodiments, containment plates 41 protrude outward obliquely (i.e., at an obtuse or acute angle) with respect to surface 30. According to the depicted embodiment, containment plates 41 are right triangular prisms. A containment plate, however, may be any suitable shape or size. Containment plates 41 are extended laterally by horizontal flanges 42 and vertical flanges 43, respectively. According to the depicted embodiment, one of the lateral containment members is a mirror image of the other lateral containment member. In some embodiments, however, the lateral containment members may be substantially identical or dissimilar.

In some embodiments, lateral containment members 4 are operatively coupled to support member 3 such that when asphalt is provided to distribution compartment 1, the asphalt is inhibited from escaping the distribution compartment laterally. Thus, in such embodiments, asphalt distribution system 1 is advantageously configured to distribute asphalt in a neat strip while reducing the amount of wasted material. For example, surfaces 48 (see FIG. 2A) of the lateral containment members are complementary to surface 30 of the support member. Further, as depicted in FIG. 2, surfaces 48 of the lateral containment members 4 abut surface 30 of support member 3.

Distribution device 10 further includes laterally elongated element 5 coupled to support member 3. Elongated element 5 is positioned horizontally and parallel to support member 3. According to the depicted embodiment, elongated element 5 includes horizontal portion 51 and vertical portion 52. Additionally, the length of elongated element 5 is approximately equal to the length of the support member 3. An elongated element, however, may be any suitable shape or size and positioned in any suitable orientation. For example, an elongated element may include one or more substantially convex or concave portions. Additionally, an elongated element may include one or more angulated portions. Further, an elongated element may be positioned at an oblique angle with respect to the support member. Portion 52 of the elongated element includes leveling surfaces 53. An elongated element may be formed from any suitable material. In some embodiments, an elongated element is formed of one or more hardened steels (i.e., a steel with a Brinell hardness above 400). According the depicted embodiment, elongated element 5 is substantially straight edged with a continuous leveling surface 53. Such an elongated element may advantageously provide a more consistently level mat of asphalt compared to an elongated element with multiple discrete leveling surfaces.

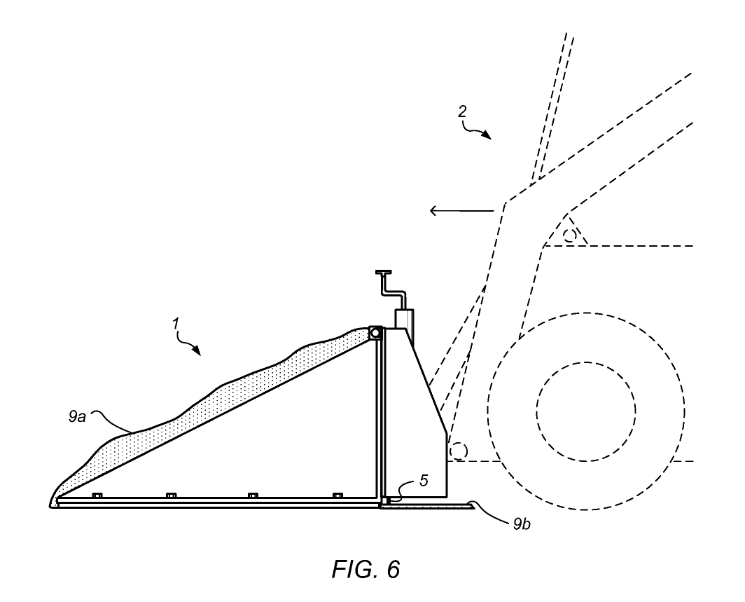

FIG. 6 depicts the leveling action of elongated element 5, during use, when distribution compartment 1 is propelled by vehicle 2. According to the depicted embodiment, when distribution compartment 1 contains asphalt 9a and is propelled, asphalt 9a is fed into the leveling surfaces of elongated element 5 to distribute asphalt in a planar mat 9b.

The distance between the inner faces of containment plates 41 is considered the effective width 8 of distribution compartment 1 (see FIG. 4). In some embodiments, the width of the distributed asphalt is determined by effective width 8 of distribution compartment 1. Thus, the width of the distributed asphalt may be adjusted by altering distribution compartment 1 as opposed to elongated element 5. As such, asphalt distribution device 10 may be provided with a single, substantially straight edged elongated element 5 with a continuous leveling surface 53. In some embodiments, the width of the distributed asphalt is substantially equal to effective width 8 of the distribution compartment. For example, as depicted in FIGS. 2-5, when the length of the elongated element is greater than or equal to the effective width of the distribution compartment and when the containment plates protrude outward normally from the support member, the width of the distributed asphalt is substantially equal to the effective width of the distribution compartment.

Lateral containment members 4 further include collars 44. Collars 44 of lateral containment members 4 include apertures 46. Apertures 46 receive elongated shaft 32, thereby directly connecting lateral containment members 4 to the elongated shaft and coupling the containment members to support member 3. In some embodiments, at least one of collars 44 is slidable along the outer surface of elongated shaft 32. As such, the lateral containment member(s) having the slidable collar(s) is laterally moveable with respect to the support member. Thus, effective width 8 of distribution compartment 1 may be adjusted by laterally moving at least one of lateral containment members 4 towards or away from the other lateral containment member. Similarly, in some embodiments, a selected width of distributed asphalt may be achieved by positioning at least one of lateral containment member 4 at a selected location on support member 3.

Lateral containment members 4 further include apertures 47 located on vertical flanges 43. In some embodiments, apertures 47 are aligned on the same horizontal plane as apertures 31 of support member 3. During use, either of lateral containment members 4 may be fixedly coupled to support member 3 at a selected location by disposing mechanical fasteners 49 through apertures 47 and any one of apertures 31 when the apertures are coaxially aligned.

Distribution device 10 further includes ground engaging elements 45 coupled to horizontal flanges 42. According to the depicted embodiment, ground engaging elements 45 are coupled to horizontal flanges 42 via mechanical fasteners 40 disposed in apertures 50. Ground engaging elements 45, however, may be coupled to horizontal flanges 42 by any means and/or method. For example, the ground engaging elements may be welded to the horizontal flanges of the lateral containment members. A ground engaging element may be formed from any suitable material. In some embodiments, ground engaging elements are formed of one or more metal carbides (e.g., tungsten carbide, titanium carbide, boron carbide). During use, when asphalt distribution device 10 is propelled, ground engaging elements 45 may slide along the ground, thereby supporting the asphalt distribution device and preventing wear of the other constituent parts of the asphalt distribution device.

In some embodiments, an asphalt distribution device includes a vertical displacement device for vertically displacing the elongated element relative to the support member. For example, according to the depicted embodiments, asphalt distribution device 10 includes vertical displacement devices 6 coupled to support member 3. Vertical displacement devices 6 include longitudinal housings 61. Longitudinal housings 61 are coupled to support member 3 via plate 64. Shafts 62 are coupled to longitudinal housings 61. In some embodiments, shafts 62 are telescopically coupled to longitudinal housings 61. Shafts 62 may be advanceable and retractable into and from longitudinal housings 61. In some embodiments, shafts 62 are pneumatically retracted and advanced into and from the longitudinal housings. In some embodiments, shafts 62 are mechanically retracted and advanced into and from the longitudinal housings. For example, vertical displacement devices 6 include handles 65 operatively coupled to longitudinal housings 61 for mechanically retracting and advancing shafts 62. A vertical displacement device may include any number of shafts and/or housings. Although, vertical displacement devices 6 as depicted in FIGS. 2-5 include the elements described above in order to vertically displace the elongated element relative to the support member, any known means of facilitating such displacement may be used. For example, a vertical displacement device may include one or more rollers, rails, pulleys, and/or other mechanical or pneumatic components to facilitate vertical displacement of the elongated element.

Elongated element 5 is coupled to shaft 62 such that movement of the shaft raises or lowers the elongated element relative to support member 3. In certain embodiments, when the shaft is advanced from the longitudinal housing, the elongated element is lowered with respect to the support member and when the shaft is retracted into the longitudinal housing, the elongated element is raised with respect to the support member. In some embodiments, the asphalt distribution device includes a stopping member configured to inhibit the vertical displacement of the elongated element. For example, according to the depicted embodiment, asphalt distribution device 10 includes stopping member 66 coupled to brackets 33. Brackets 33 are coupled to support member 3. Brackets 33 are located at opposing lateral ends of support member 3. Surface 67 of the stopping member is complementary to surface 55 of portion 51 of elongated element 5. In some embodiments, stopping member 66 is located below portion 51 such that surface 55 may abut surface 66 and prevent further lowering of the elongated member.

A method of distributing asphalt includes obtaining an asphalt distribution device, loading asphalt into the distribution compartment of the device and propelling the distribution compartment to distribute asphalt.

In some embodiments, the method further includes moving at least one of the lateral containment members towards or away from the other lateral containment member such that the effective width of the distribution compartment is substantially equal to a selected width of the asphalt mat. In some embodiments, the method further includes vertically displacing the elongated element relative to the support member such that the vertical distance from the elongated element to a level portion of the ground is substantially equal to a selected thickness of the asphalt mat. In certain embodiments, the method still further includes, arresting movement of the distribution compartment such that the distribution of asphalt is substantially ceased and adjusting the effective width of the distribution compartment and/or the vertical displacement of the elongated element as described above to distribute asphalt at an alternative selected width and/or thickness.

In some embodiments, the method further includes intermittently providing additional asphalt to the distribution compartment during use.

During use, the properties of the asphalt may vary over time. For example, asphalt provided to the distribution compartment may cool over time, thereby altering the material properties of the asphalt. As such, it may be advantageous to increase the speed at which the asphalt is distributed. The speed of distribution may be determined by the speed at which the distribution compartment is propelled. In some embodiments, distribution compartment 1 is propelled at a speed of at least about 1 to 6 mph. In certain embodiments, distribution compartment 1 is propelled at a speed of at least about 1 to 3 mph.

In some embodiments, a method of manufacturing an asphalt distribution device includes coupling a laterally elongated element to a support member and coupling two or more lateral containment members to the support member. In certain embodiments, the lateral containment members are operatively coupled to the support member such that, during use, when asphalt is provided to the distribution compartment, the asphalt is inhibited from escaping the distribution compartment laterally. In certain embodiments, the lateral containment members are operatively coupled to the support member such that width of the distributed asphalt is adjustable by moving at least one of the lateral containment members towards or away from at least one other lateral containment member.

In some embodiments the method further includes coupling the asphalt distribution device to a vehicle. In certain embodiments, the asphalt distribution device is coupled to a vehicle by coupling the support member to the vehicle.

In some embodiments, the method further includes coupling an elongated shaft to the support member, and operatively coupling at least one of the lateral containment members to the shaft such that at least one lateral containment member is slidable thereon. In various embodiments, the method still further includes providing the asphalt distribution device with means for fixedly coupling at least one of the lateral containment members to the support member. In certain embodiments, such means include a plurality of apertures located on the support member and an aperture located on at least one containment member, the apertures being located on the same horizontal plane and configured to receive a mechanical fastener.

In some embodiments, the method further includes operatively coupling at least one vertical displacement device to the elongated element for vertically displacing the elongated element relative to the support member. For example, the method may include coupling at least one housing to the support member, coupling a shaft to the housing, and coupling the elongated element to the shaft. In certain embodiments, the shaft is operatively coupled to the housing such that the shaft is retractable and advanceable into and from the housing. In certain embodiments, the elongated element is operatively coupled to the shaft such that movement of the shaft lowers and raises the elongated element.

In some embodiments, the method further includes coupling at least one ground engaging element to at least one containment member.

In this patent, certain U.S. patents, and U.S. patent applications have been incorporated by reference. The text of such U.S. patents and U.S. patent applications is, however, only incorporated by reference to the extent that no conflict exists between such text and the other statements and drawings set forth herein. In the event of such conflict, then any such conflicting text in such incorporated by reference U.S. patents and U.S. patent applications is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system for distributing asphalt comprising:
a vehicle;
a distribution compartment coupled to the vehicle, the distribution compartment comprising:
a support member;
a laterally elongated element coupled to the support member;
two or more lateral containment members operatively coupled to the support member and extending outward therefrom such that when asphalt is provided to the distribution compartment, the asphalt is inhibited from escaping the distribution compartment laterally,
wherein at least one of the lateral containment members is laterally movable such that, during use, the width of the distributed asphalt is adjusted by moving at least one of the lateral containment members towards or away from at least one other lateral containment member.

2-15. (canceled)

16. An asphalt distribution attachment device for a vehicle comprising:
a support member couplable to at least a portion of the vehicle;
a laterally elongated element coupled to the support member;
two or more lateral containment members operatively coupled to the support member and extending outward therefrom such that when asphalt is provided to the distribution compartment, the asphalt is inhibited from escaping the distribution compartment laterally,
wherein at least one of the lateral containment members is laterally movable with respect to the support member such that, during use, the width of the distributed asphalt is adjusted by moving at least one of the lateral containment members towards or away from one other lateral containment member.

17. The device of claim 16, wherein the distribution compartment is coupled to the leading end of the vehicle.

18. The device of claim 16, wherein the distribution compartment is configured such that the width of the distributed asphalt is substantially equal to the effective width of the distribution compartment.

19. The device of claim 16, wherein the maximum effective width of the distribution compartment is at most about 5 feet.

20. The device of claim 16, wherein the length of the elongated element is substantially equal to the length of the support member.

21. The device of claim 16, further comprising an elongated shaft coupled to the support member, and wherein at least one of the lateral containment members is coupled to the shaft and slidable thereon.

22. The device of claim 16, further comprising at least one operatively coupled to the elongated element for vertically displacing the elongated element relative to the support member.

23. The device of claim 16, further comprising:
at least one housing coupled to the support member;
at least one shaft coupled to at least one housing, wherein the shaft is retractable and advanceable into and from the housing; and
wherein the elongated element is operatively coupled to the shaft such that, during use, movement of the shaft lowers or raises the elongated element.

24. The device of claim 23, wherein the shaft is pneumatically retracted and advanced into and from the housing during use.

25. The device of claim 23, wherein the shaft is mechanically retracted and advanced into and from the housing during use.

26. The device of claim 16, further comprising:
at least one longitudinal housing coupled to the support member;
at least one shaft telescopically coupled to at least one longitudinal housing, wherein the shaft is retractable and advanceable into and from the longitudinal housing; and
wherein the elongated element is operatively connected to the distal end the shaft such that, during use, when the telescopic shaft is advanced from the longitudinal housing, the elongated element is lowered with respect to the support member and when the shaft is retracted into the longitudinal housing, the elongated element is raised with respect to the support member.

27. The device of claim 16, further comprising at least one ground engaging element coupled to at least one containment member.

28. A method of distributing asphalt comprising:
obtaining an asphalt distribution device comprising:
a support member;
a laterally elongated element coupled to the support member;
two or more lateral containment members operatively coupled to the support member and extending outward therefrom such that when asphalt is provided to the distribution compartment, the asphalt is inhibited from escaping the distribution compartment laterally,
wherein at least one of the lateral containment members is laterally movable with respect to the support member,
loading asphalt into the distribution compartment; and
propelling the distribution compartment to distribute asphalt.

29-42. (canceled)
